(19) United States
(12) Patent Application Publication
(10) Pub. No.: US 2022/0215505 A1
(43) Pub. Date: Jul. 7, 2022

(54) SYSTEM AND METHOD OF PROCESSING OF A CAPTURED IMAGE TO FACILITATE POST-PROCESSING MODIFICATION

(71) Applicants: Michael BROWN, Toronto (CA); Mahmoud AFIFI, North York (CA); Abdelrahman ABDELHAMED, Toronto (CA); Hakki KARAIMER, North York (CA); Abdullah ABUOLAIM, North York (CA); Abhijith PUNNAPPURATH, North York (CA)

(72) Inventors: Michael BROWN, Toronto (CA); Mahmoud AFIFI, North York (CA); Abdelrahman ABDELHAMED, Toronto (CA); Hakki KARAIMER, North York (CA); Abdullah ABUOLAIM, North York (CA); Abhijith PUNNAPPURATH, North York (CA)

(21) Appl. No.: 17/602,468

(22) PCT Filed: Apr. 9, 2020
(86) PCT No.: PCT/CA2020/050465

§ 371 Date: Oct. 8, 2021

Related U.S. Application Data
(60) Provisional application No. 62/831,442, filed on Apr. 9, 2019.

(51) Int. Cl. G06T 3/40; G06T 3/00; G06T 1/20

(52) U.S. Cl. CPC G06T 3/40; G06T 1/20; G06T 3/0031

(57) ABSTRACT

A system and method of processing of a captured image to facilitate post-processing modification. The method includes: receiving the captured image; down-sampling the captured image to generate a down-sampled image; passing the captured image through an image processing pipeline to generate an initial output image, the image processing pipeline including performing one or more image processing operations on the passed image based on a set of parameters; iteratively passing, in one or more iterations, the down-sampled image through the image processing pipeline to generate an output down-sampled image in each iteration, each iteration using at least one variation to the set of parameters used by the image processing pipeline. Down-sampling can be used to generate a down-sampled initial output image such that a mapping is determined between the down-sampled initial output image and the respective output down-sampled image. The down-sampled images or the mapping can be stored as metadata.

### TECHNICAL FIELD

The present disclosure relates generally to image capture and processing. More particularly, the present disclosure relates to a system and method of processing of a captured image to facilitate post-processing modification.

### BACKGROUND

When a digital image is captured, for example with a digital camera, several image processing operations are generally performed to convert the captured scene radiance into an appropriate image; for example, into a visually pleasing image. An image processor (IP) located in the camera, or located remote to the camera, performs these operations in a sequential image processing pipeline to convert the scene-referred image I recorded by the sensor to the final output-referred image O produced by the IP. Generally, as the input image I is passed through the image processing operations in the pipeline, each operation generally alters the image until the output image O is produced; in this way, the intermediary images and any changes applied from each operation are discarded and not retained. Thus, the output image O is dependent on the settings used by the IP.

### SUMMARY

In an aspect, there is provided a method of processing of a captured image to facilitate post-processing modification, the method executed on one or more processors, the method comprising: receiving the captured image; down-sampling the captured image to generate a down-sampled image; passing the captured image through an image processing pipeline to generate an initial output image, the image processing pipeline comprising performing one or more image processing operations on the passed image based on a set of parameters; iteratively passing, in one or more iterations, the down-sampled captured image through the image processing pipeline to generate an output down-sampled image for each iteration, each iteration using at least one variation to the set of parameters used by the image processing pipeline; and storing the initial output image and the one or more output down-sampled images.

In a particular case of the method, the method further comprising: associating the one or more output down-sampled images with the initial output image; and outputting the initial output image with the associated one or more output down-sampled images.

In another case, of the method associating the one or more output down-sampled images with the initial output image comprises storing the one or more output down-sampled images as metadata to the initial output image.

In yet another case of the method, the method further comprising storing the down-sampled captured image as metadata to the initial output image.

In yet another case of the method, the method further comprising determining a mapping between the down-sampled captured image and the captured image, and storing the mapping as metadata to the initial output image.

In yet another case of the method, one of the image processing operations comprises performing white-balancing, and wherein the variation in the set of parameters comprises variations of color temperature for the white-balance.

In yet another case of the method, the method further comprising: down-sampling the initial output image to generate a down-sampled initial output image, the down-sampled initial output image comprising dimensions equivalent to the one or more output down-sampled images; and for each of the output down-sampled images, determining a mapping between the down-sampled initial output image and the respective output down-sampled image.

In yet another case of the method, associating the one or more output down-sampled images with the initial output image comprises storing the mapping for each of the output down-sampled images as metadata to the initial output image.

In yet another case of the method, the mapping comprises a nonlinear mapping function that minimizes error between colors in the down-sampled initial output image and the respective output down-sampled image comprising the at least one variation to the set of parameters used by the image processing pipeline.

In yet another case of the method, the method further comprising using a kernel function to transform red, green and blue (RGB) triplets of the down-sampled initial output image to a dimensional space that is greater than three dimensions, the minimization of error between the colors comprising minimizing a squared-distance between the down-sampled initial output image in the dimensional space and the respective output down-sampled image.

In yet another case, the kernel function output comprising: (R, G, B, R², G², B², RG, RB, GB, R³, G³, B³, RG², RB², GB², GR², BG², BR², RGB, R⁴, G⁴, B⁴, R³G, R³B, G³R, G³B, B³R, B³G, R²G², G²B², R²B², R²GB, G²RB, B²RG)^{T}.

In yet another case of the method, the method further comprising: associating the one or more mappings with the initial output image by storing the one or more output down-sampled images as metadata to the initial output image; and outputting the initial output image with the associated one or more mappings.

In yet another case of the method, the method further comprising: generating a modified output image by applying one of the one or more mappings to the initial output image; and outputting the modified output image.

In another aspect, there is provided a method of generating one or more modified output images from a captured image, the method executed on one or more processors, the method comprising: receiving an initial output image processed using an image processing pipeline from the captured image, the image processing pipeline comprising one or more image processing operations on the captured image based on a set of parameters; receiving one or more mappings associated with the initial output image, each of the one or more mappings having been determined from a respective mapping between a down-sampled initial output image and one of one or more output down-sampled images, the one or more output down-sampled images having been determined by iteratively passing, in one or more iterations, a down-sampled image of the captured image through the image processing pipeline, each iteration using at least one variation to the set of parameters used by the image processing pipeline; generating each of the one or more modified output images by applying one of the one or more mappings to the initial output image; and outputting at least one of the modified output images.

In yet another aspect, there is provided a system of processing of a captured image to facilitate post-processing modification, the system comprising one or more processors and one or more non-transitory computer storage media, the one or more non-transitory computer storage media comprising instructions that cause the one or more processors to execute: an input module to receive the captured image; a down-sampling module to down-sample the captured image to generate a down-sampled image; and an image processing module to pass the captured image through an image processing pipeline to generate an initial output image, the image processing pipeline comprising performing one or more image processing operations on the passed image based on a set of parameters, and to iteratively pass, in one or more iterations, the down-sampled captured image through the image processing pipeline to generate an output down-sampled image for each iteration, each iteration using at least one variation to the set of parameters used by the image processing pipeline.

In a particular case of the system, the one or more processors further execute an output module to associate the one or more output down-sampled images with the initial output image, and to output the initial output image with the associated one or more output down-sampled images.

In another case of the system, associating the one or more output down-sampled images with the initial output image comprises storing the one or more output down-sampled images as metadata to the initial output image.

In yet another case of the system, the down-sampling module further down-samples the initial output image to generate a down-sampled initial output image, the down-sampled initial output image comprising dimensions equivalent to the one or more output down-sampled images, and the one or more processors further execute a mapping module to, for each of the output down-sampled images, determine a mapping between the down-sampled initial output image and the respective output down-sampled image.

In yet another case of the system, the mapping comprises a nonlinear mapping function that minimizes error between colors in the down-sampled initial output image and the respective output down-sampled image comprising the at least one variation to the set of parameters used by the image processing pipeline.

In yet another case of the system, the mapping module further uses a kernel function to transform red, green and blue (RGB) triplets of the down-sampled initial output image to a dimensional space that is greater than three dimensions, the minimization of error between the colors comprising minimizing a squared-distance between the down-sampled initial output image in the dimensional space and the respective output down-sampled image.

In yet another case of the system, the one or more processors further execute an output module to associate the one or more mappings with the initial output image by storing the one or more output down-sampled images or the mappings as metadata to the initial output image, and to output the initial output image with the associated one or more mappings.

In yet another case of the system, the mapping module further generates a modified output image by applying one of the one or more mappings to the initial output image, and the one or more processors further execute an output module to output the modified output image.

These and other aspects are contemplated and described herein. It will be appreciated that the foregoing summary sets out representative aspects of systems and methods to assist skilled readers in understanding the following detailed description.

### BRIEF DESCRIPTION OF THE DRAWINGS

The features of the invention will become more apparent in the following detailed description in which reference is made to the appended drawings wherein:

FIG. 1 is a block diagram of a system of processing of a captured image to facilitate post-processing modification, in accordance with an embodiment;

FIG. 2 is a flowchart of a method of processing of a captured image to facilitate post-processing modification, in accordance with an embodiment;

FIG. 3 is a block diagram illustrating an example image processing pipeline according to certain image processing approaches;

FIG. 4 is a block diagram illustrating an example image processing pipeline, in accordance with the embodiment of FIG. 1;

FIG. 5 shows example images outputted by an example image processing pipeline having different white-balance parameters and images outputted in post-processing by the embodiment of FIG. 1 having different white-balance parameters; and

FIG. 6 illustrates an example flow diagram for generating an initial output image with associated mappings for down-sampled modified images, in accordance with the embodiment of FIG. 1.

### DETAILED DESCRIPTION

Embodiments will now be described with reference to the figures. For simplicity and clarity of illustration, where considered appropriate, reference numerals may be repeated among the Figures to indicate corresponding or analogous elements. In addition, numerous specific details are set forth in order to provide a thorough understanding of the embodiments described herein. However, it will be understood by those of ordinary skill in the art that the embodiments described herein may be practiced without these specific details. In other instances, well-known methods, procedures and components have not been described in detail so as not to obscure the embodiments described herein. Also, the description is not to be considered as limiting the scope of the embodiments described herein.

Various terms used throughout the present description may be read and understood as follows, unless the context indicates otherwise: “or” as used throughout is inclusive, as though written “and/or”; singular articles and pronouns as used throughout include their plural forms, and vice versa; similarly, gendered pronouns include their counterpart pronouns so that pronouns should not be understood as limiting anything described herein to use, implementation, performance, etc. by a single gender; “exemplary” should be understood as “illustrative” or “exemplifying” and not necessarily as “preferred” over other embodiments. Further definitions for terms may be set out herein; these may apply to prior and subsequent instances of those terms, as will be understood from a reading of the present description.

Any module, unit, component, server, computer, terminal, engine or device exemplified herein that executes instructions may include or otherwise have access to computer readable media such as storage media, computer storage media, or data storage devices (removable and/or non-removable) such as, for example, magnetic disks, optical disks, or tape. Computer storage media may include volatile and non-volatile, removable and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by an application, module, or both. Any such computer storage media may be part of the device or accessible or connectable thereto. Further, unless the context clearly indicates otherwise, any processor or controller set out herein may be implemented as a singular processor or as a plurality of processors. The plurality of processors may be arrayed or distributed, and any processing function referred to herein may be carried out by one or by a plurality of processors, even though a single processor may be exemplified. Any method, application or module herein described may be implemented using computer readable/executable instructions that may be stored or otherwise held by such computer readable media and executed by the one or more processors.

The following relates generally to image capture and processing. More particularly, the following relates to a system and method of processing of a captured image to facilitate post-processing modification.

While the following describes a scene-referred image I (also referred to as a sensor image or captured image) captured by a camera, it is to be understood that any suitable image capture device and/or sensor can be used; for example, a video-camera, a webcam, a camera capturing light outside of the visible spectrum, or the like.

An image captured by a camera's sensor can be referred to as a scene-referred image I or a “raw” image. After an image is captured, several image processing operations can be performed to convert the scene-referred image I into an appropriately processed image; for example, such that the image is visually pleasing. An image processor (IP) can perform these image processing operations by following a given image processing pipeline. The image processing pipeline is thus used to convert the scene-referred image I recorded by the camera's sensor to the final output-referred image O (also referred to generally as the output image). Generally, as the input image I is passed through the image processing operations in the pipeline, each operation alters the image until the output image O is produced; in this way, the intermediary outputs and/or images from each operation are not retained.

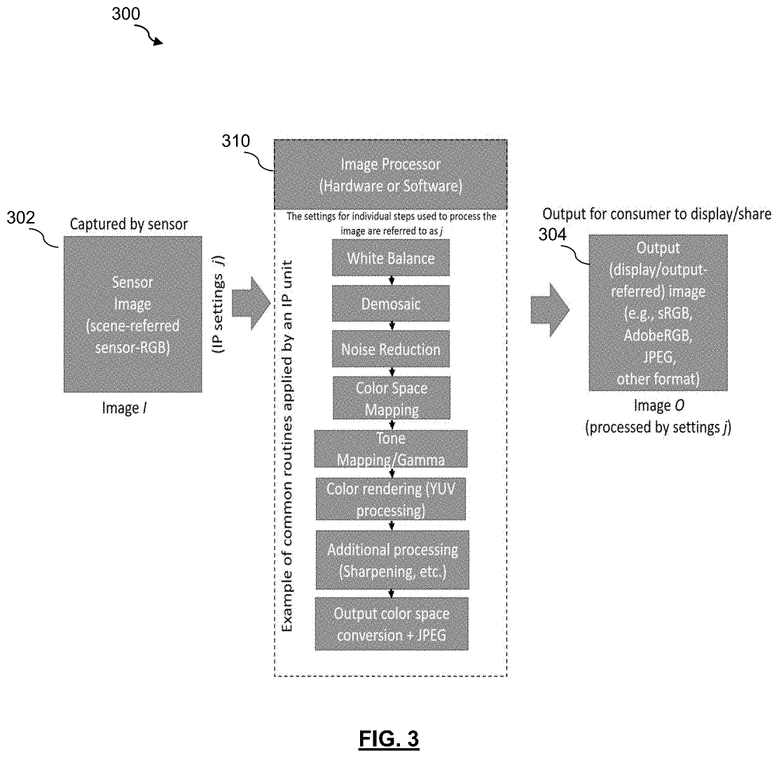

FIG. 3 shows a block diagram illustrating an example camera pipeline 300 according to certain image processing approaches. The captured image (the scene-referred image I) 302 is in the color space of the camera's sensors. The scene-referred image I 302 is then processed by the IP to produce the output-referred image O 304 by passing the scene-referred image I through an image processing pipeline 310. The image processing pipeline includes a number of individual steps/operations/routines arranged sequentially, as shown in FIG. 3. Such steps/operations/routines can include, for example, white-balance, denoising, demoasicing, color space mapping, and the like. In some cases, one or more of these routines may have settings, that can be selected by the user, or other parameters (each of these settings or parameters for individual routines is denoted by j).

The output-referred image O 304 is generally saved in an output-referred color space, for example, standard RGB (sRGB), AdobeRGB, YUV, or the like. The output image may be stored locally or uploaded to an external database or cloud storage. The output image may be compressed and stored in a format such as JPEG. In this way, output-referred image O 304 represents the scene-referred image I 302 processed by the IP pipeline 310 with settings j.

With the approach illustrated in FIG. 3, a significant problem can occur, for example, if the wrong settings j were used in the image processing pipeline. This error can generate an output-referred image O 304 that has an unwanted appearance or unwanted characteristics. For example, such an error can occur if the white-balance was selected incorrectly by the user or an auto-white-balance algorithm performed poorly or incorrectly. In the example of FIG. 3, the white-balance is applied early in the camera pipeline processing chain. If the white-balance was improperly applied and the image processed through the full pipeline, then it is technically challenging to correct the colors of the final rendered image O 304 in the output-referred format even if the right white-balance is known. This is because, for example, there are several steps in the pipeline that follow the white-balance routine. In this way, to properly correct the wrong white-balanced output image O would require accurately reversing of each of the subsequent steps applied, applying the correct white-balance, and then reapplying the subsequent steps in the pipeline with the correct settings. This reverse process of the IP is generally intractable, and at the very least impractical, as many of the pipeline steps include nonlinear transformations and many-to-one mappings that cannot be straightforwardly reversed. While the above example uses white-balance, the above also applies to other incorrect settings j and/or incorrect routine parameters; for example, wrong picture style (e.g., landscape mode, portrait mode, vivid mode, and the like), color rendering, noise reduction, and the like.

While some cameras provide users the ability to save the original raw image data recorded by the sensor, this ability is not always available and comes at a very high cost as far as file sizes and storage requirements. To overcome this limitation, some approaches attempt to linearize the sRGB output image. This process, called radiometric calibration, is closely related to raw image reconstruction. The objective of radiometric calibration is to undo the non-linear processing applied by the IP to produce the final sRGB output. Generally, radiometric calibration is a tedious procedure where a system needs to image many color charts under different lights to compute the necessary mathematical operators to perform the reversal of the IP processing.

These mathematical operators change with different settings on the camera, so the system would need to have several different mathematical models for each setting. Further, the system generally has to store this information somewhere and have it ready in the event it needs to use it. In addition, this information generally needs to work in both directions, one to reverse the output image O back to the scene-referred image I. And then another, to map the scene-referred image I back to the output image O after the modified setting is applied. Radiometric calibration to invert the IP processing has been around for a long time, but its uptake is extremely limited because it requires too much effort and storing the additional data for each image is not practical.

Other approaches use raw reconstruction techniques to convert sRGB values back to their original raw-RGB values. For example, raw-RGB reconstruction based on a guided up-sampling of a low-resolution raw image, stored along with the sRGB image, to reconstruct the full-resolution raw image. Further approaches use more complex models for the onboard camera processing stages to achieve higher raw reconstruction accuracy; however, this requires either a small raw file to be stored along with the sRGB image or involves careful camera calibration. Similar to radiometric calibration, such camera calibration generally requires the system to know how to go back to the scene-referred image I, compute modified setting, and then apply the IP again to get the corrected output image O. Advantageously, the present embodiments do no require such extra computation and storage of having to reverse the IP on the output image O to get back to the scene-referred image I.

Generally, the other approaches require attempting to get back to the raw-RGB image I 302 and then re-process the image again through the image processing pipeline 310, or some variant of the image processing pipeline. These approaches are thus computationally expensive and require access to the image processing pipeline, which may not be available if the output image O is received on a different computing device. Advantageously, the present embodiments do not require going back from the sRGB image O to the raw image I and forward again to the sRGB image O. Instead, the present embodiments provide the technical advantage of being able to perform processing of the rendered sRGB images in the sRGB color space. As described, the results of the present embodiments can appear effectively identical to an output image O if the sensor image I were processed by the image processing pipeline using a different setting.

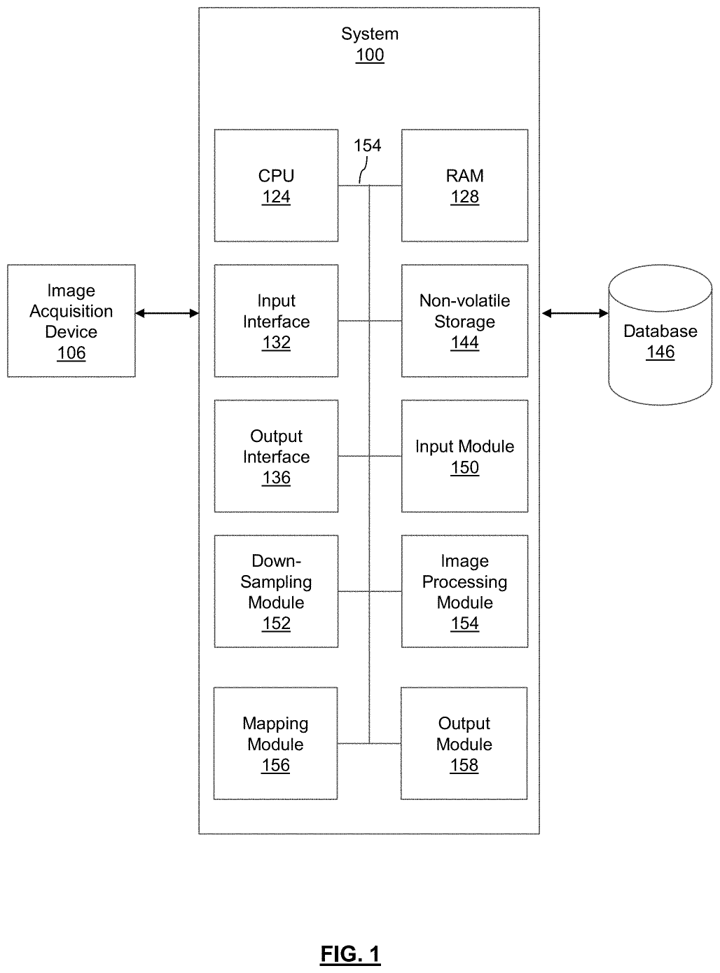

Turning to FIG. 1, shown therein is a diagram for a system of processing of a captured image to facilitate post-processing modification 100, in accordance with an embodiment. The system 100 can include a number of physical and logical components, including a central processing unit (“CPU”) 124, random access memory (“RAM”) 128, an input interface 132, an output interface 136, memory comprising non-volatile storage 144, and a local bus 154 enabling CPU 124 to communicate with the other components. CPU 124 can include one or more processors. RAM 128 provides relatively responsive volatile storage to CPU 124. The input interface 132 enables a user to provide input via, for example, a touchscreen. The output interface 136 outputs information to output devices, for example, to the touchscreen. Non-volatile storage 144 can store computer-executable instructions for implementing the system 100, as well as any derivative or other data. In some cases, this data can be stored or synced with a database 146, that can be local to the system 100 or remotely located (for example, a centralized server or cloud repository). During operation of the system 100, data may be retrieved from the non-volatile storage 144 and placed in RAM 128 to facilitate execution. In an embodiment, the CPU 124 can be configured to execute various modules, for example, an input module 150, a down-sampling module 152, an image processing module 154, a mapping module 156, and an output module 158.

In an embodiment, the system 100 can be located on an image capture device 106; such as a camera. In this case, the system can be implemented, for example, with general or specialized computing components, or with a system-on-chip (SoC) implementation. In other cases, the system 100 can be located separate or remote from the image capture device 106. In this case, the system 100 may receive the data comprising the scene-referred image I 302 via a communication link or network, for example, the Internet.

Advantageously, the present embodiments overcome substantial challenges in the art by, for example, providing an approach that significantly facilitates post-processing correction of images incorrectly or inopportunely processed by an image processing pipeline, such as those in a camera. For example, it can be a substantial advantage that the present embodiments can be used to produce output images that appear almost identical to what the image processing pipeline would have produced if different settings j were applied.

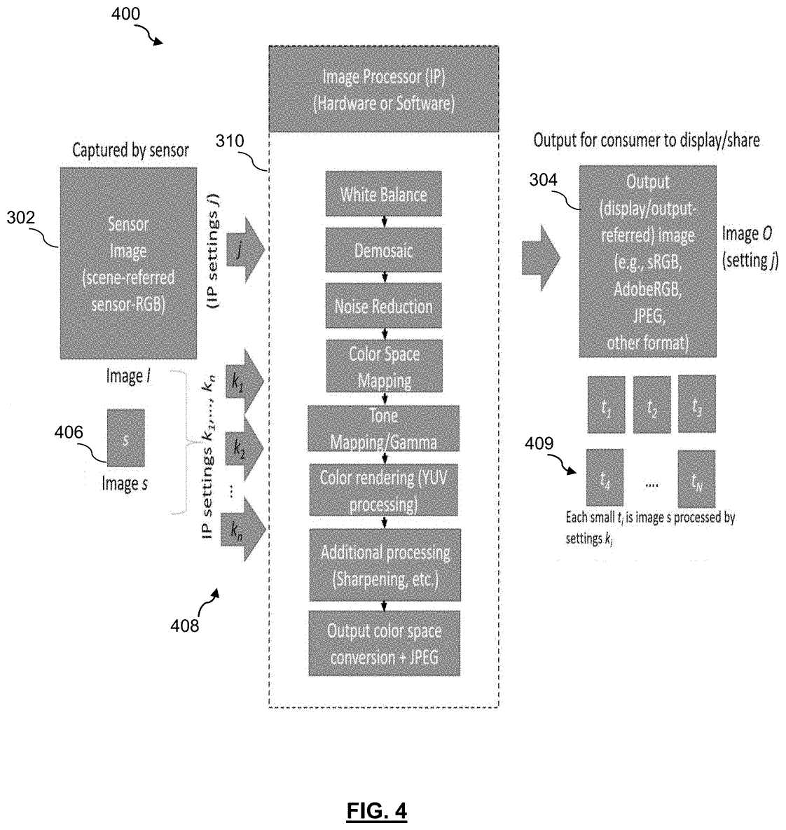

As illustrated in FIG. 4, in an example approach 400 of embodiments described herein, a down-sampled (small) copy 406 of the captured sensor image I 302 is generated. The down-sampled copy 406 is denoted as s and is intended to be considerably smaller in pixel-size (and thus, data size); for example, 1/10, 1/20, 1/30, or 1/50 times the size of the full size image I. The down-sampled image s 406 can then be processed by the image processing pipeline 310 one or more times. Each time the down-sampled image s is processed with different settings, denoted {kᵢ}^{N}ᵢ₌₁. For example, many cameras have pre-set white-balance settings, and {kᵢ}^{N}ᵢ₌₁ can be each of these pre-set white-balance settings. In this example, each of the white-balance pre-set settings can be related to a type of light source (for example, tungsten, fluorescent, sunlight, or the like) or to a color temperature (for example, 2500K, 3800K, 6500K, or the like). In FIG. 4, the resulting down-sampled images 409 processed by the image processing pipeline are denoted as {tᵢ}^{N}ᵢ₌₁ corresponding to the settings {kᵢ}^{N}ᵢ₌₁ 408. In some cases, the resulting down-sampled images 409 are of a size that can be directly stored as metadata associated with the output image O 304. In further cases, the resulting down-sampled images 409 can be stored as non-displayed pixels associated with the output image O 304. In an example, the data can be stored as comment fields in a JPEG file that stores the image.

Advantageously, the resulting down-sampled images {tᵢ}^{N}ᵢ₌₁ 409 provide sufficient information to estimate mathematical operators {Mᵢ}^{N}ᵢ₌₁ that allow the RGB values in the image O 304 to be transformed to the RGB values in {tᵢ}^{N}ᵢ₌₁. The operators {Mᵢ}^{N}ᵢ₌₁ in turn allow for the transformation of color values (post-processing) in image O that was captured with settings j such that it effectively appears as if image O were originally processed with the image processing pipeline using settings {kᵢ}^{N}ᵢ₌₁.

In further cases, the mapping operators {Mᵢ}^{N}ᵢ₌₁ can be stored in the metadata associated with the image O instead of the resulting down-sampled images {tᵢ}^{N}ᵢ₌₁ 409 as described above. In this case, the values representing {Mᵢ}^{N}ᵢ₌₁ will generally require even less storage than the resulting down-sampled images {tᵢ}^{N}ᵢ₌₁ 409. Advantageously, the present embodiments can require minimal metadata to be embedded or otherwise associated with the image O. Thus, the present embodiments can store metadata necessary to provide post-processing on each image O such as to appear is if it was captured with different camera settings. This is a substantial technical improvement over the art because, for example, generally there were very limited and mostly ineffective post-processing that could be done to an output image 304 after it was already processed by the image processing pipeline. For example, other attempts to conduct white-balance correction post-hoc on the output image O are generally ineffective; for example, because the IP can work at a higher bit-depth prior to doing conversion to an image color-space, because the IP generally operates on linear values rather than gamma values, and because of the accumulation of errors when performing post-hoc white-balancing.

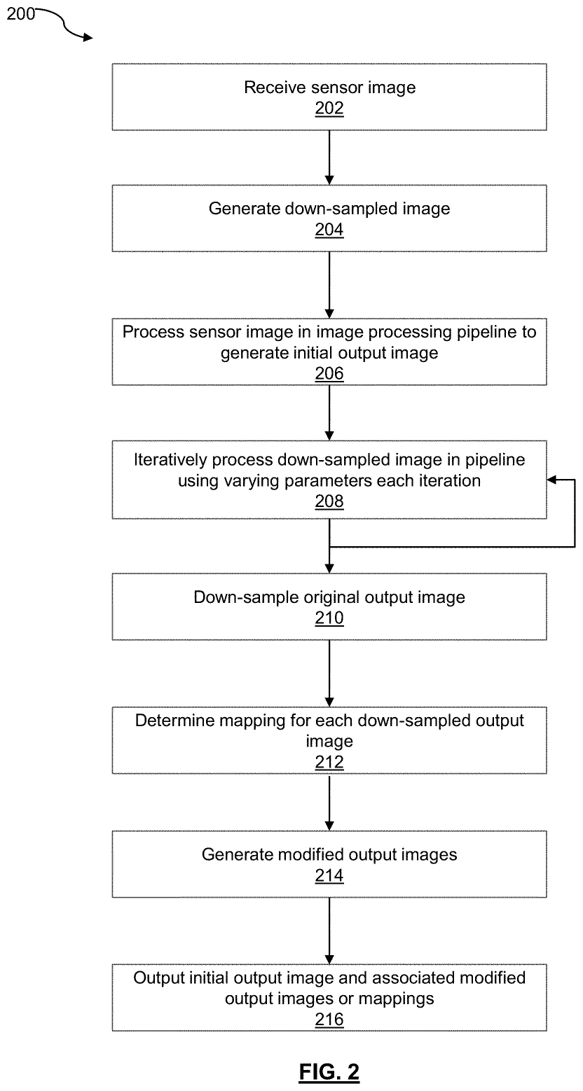

Turning to FIG. 2, shown therein is a flowchart for a method of processing of a captured image to facilitate post-processing modification 200, in accordance with an embodiment.

At block 202, the input module 150 receives a sensor image I. For example, from a camera sensor on an image acquisition device 106 or from a database 146. In some cases, the sensor image I can be referred to as a “raw image.”

Blocks 204 to 208 generally illustrate the generation of an output image with associated down-sampled images. At block 204, the down-sampling module 152 generates a down-sampled image s of the sensor image I. The down-sampled image s having a fraction of the resolution of the sensor image I; for example, 1/50^{th} the resolution of the sensor image I.

The down-sampling module 152 can use any suitable approach to down-sample images. For example, performing an interpolating or weighted averaging function that averages pixels in a given window that is related to the size of the down sampled image; in this case, effectively the average color in this window is recorded for the down-sampled image. In a particular example, nearest-neighbor interpolation can be used that down-samples the image by taking samples in either a grid structure or in a more complex structure (e.g., Voronoi diagram). Other more complex algorithms may be used for interpolation in order to reduce the artifacts in the down-sampled image (e.g., bilinear and bicubic interpolations). Other down-sampling techniques include: Box sampling, Mipmap, Fourier-transform-based methods, deep convolutional neural networks (CNNs), pixel skipping, or the like.

At block 206, the image processing module 154 performs one or more operations on the sensor image I by passing the sensor image I through the operations of an image processing pipeline. The output of the image processing pipeline is an output image O; for example, an sRGB image. The output image O is then stored in memory. Each of the operations of the image processing pipeline using one or more parameters; the set of parameters collectively referred to as j.

At block 208, the image processing module 154 iteratively, for one or more N iterations, performs the one or more operations of the image processing pipeline on the down-sampled image s. With each iteration i, the image processing module 154 changes at least one of the parameters of at least one of the operations of the image processing pipeline; each changed set of parameters referred to as kᵢ, where {kᵢ}^{N}ᵢ₌₁. In an example, the image processing module 154 could iteratively process the down-sampled image s with different pre-set values for the white-balance parameter: tungsten, fluorescent, daylight, and the like. In further examples, the differing parameters can include sharpening operations turned off, noise reduction operations turned off, different color rendering/encoding paradigms, or the like. The output of each iteration of the image processing pipeline is an output down-sampled image tᵢ, where {tᵢ}^{N}ᵢ₌₁ represents the total set of output down-sampled images. The set of output down-sampled images {tᵢ}^{N}ᵢ₌₁ can be stored in memory separately or associated with the output image O, for example, as metadata associated with the output image O. In further cases, set of output down-sampled images {tᵢ}^{N}ᵢ₌₁ can be stored as non-displayed pixels associated with the output image O.

In some cases, one of the output down-sampled images tᵢ can include just the down-sampled image s without any operations of the image processing pipeline applied (equivalent to having the pipeline operations disabled), or with only a selected subset of the pipeline operations applied. In further cases, the metadata can include the mapping operator Mᵢ from the down-sampled image s to the sensor image I. Thus, in either case, the respective mapping operator Mᵢ can be applied to the down-sampled image s to arrive back at the sensor image I. Advantageously, this allows the raw image to be retained for post-processing, such as by photo editing software, without requiring saving the large file size raw image itself.

Blocks 210 to 214 generally illustrate acquiring a modified output image having changed properties based on different parameters. For example, changing output image O to appear as if it was processed with one of the changed parameter sets kᵢ. In order to arrive at the modified output image O_{modified}, the mapping module 156 determines one or more color mapping operators Mᵢ.

At block 210, the down-sampling module 152 down-samples the initial output image O to have the same pixel dimensions as the set of output down-sampled images {tᵢ}^{N}ᵢ₌₁. The down-sampled initial output image O, with parameter set j, can be referred to as Oₛₘₐₗₗ.

At block 212, for each output down-sampled image tᵢ, the mapping module 156 determines a nonlinear mapping function Mᵢ: [symbol] ^{μ}→ [symbol] ³, which maps Oₛₘₐₗₗ to tᵢ, by determining the following minimization:

$${arg min}_{{M}_{i}} {‖ {M}_{i} Φ ( {O}_{small} ) - {t}_{i} ‖}_{F}^{2} , \qquad ( 1 )$$

where Φ: [symbol] ³→ [symbol] ^{μ} is a kernel function that transforms the RGB triplet to a μ-dimensional space, and where μ>3 and ∥·˜II_{F} denotes the Frobenius norm. For each output down-sampled image tᵢ, the above determination finds a mapping, Mᵢ, that minimizes the errors between the RGB colors in the down-sampled initial output image Oₛₘₐₗₗ and its corresponding output down-sampled image tᵢ. The set of mappings Mᵢ can be stored in memory separately or associated with the output image O, for example, as metadata associated with the output image O. In some cases, where the set of output down-sampled images {tᵢ}^{N}ᵢ₌₁ are stored as metadata, the mappings, Mᵢ, can be determined when the changed output image O is required to be determined. In other cases, where the mappings, Mᵢ, are stored as metadata associated with the initial output image O, the set of output down-sampled images {tᵢ}^{N}ᵢ₌₁ can be discarded after the mappings are determined; for example, when the output image O and its associated metadata are committed to memory. In an example, metadata can include storing the mappings, Mᵢ, is comment fields associated with JPEG images.

It is contemplated that various suitable kernel functions and dimensions of the a μ-dimensional space may be used. As an example, TABLE 1 shows examples of different kernel functions that can be used. The first column represents the dimensions of the output vector of the corresponding kernel function in the second column. The term PK refers to a polynomial kernel, while the term RPK refers to root polynomial kernel.

TABLE 1

| Dimensions | Kernel function output |
|---|---|
| 9 (PK) | (R, G, B, R², G², B², RG, RB, GB)^{T} |
| 11 (PK) | (R, G, B, RG, RB, GB, R², G², B², RGB, 1)^{T} |
| 19 (PK) | (R, G, B, R², G², B², RG, RB, GB, R³, G³, B³, RG², RB², GB², GR², BG², BR², RGB)^{T} |
| 34 (PK) | (R, G, B, R², G², B², RG, RB, GB, R³, G³, B³, RG², RB², GB², GR², BG², BR², RGB, R⁴, |
| | G⁴, B⁴, R³G, R³B, G³R, G³B, B³ R, B³G, R²G², G²B², R²B², R²GB, G²RB, B²RG)^{T} |
| 6 (RPK) | (R, G, B, \sqrt{RG}, \sqrt{GB}, \sqrt{RB})^{T} |
| 13 (RPK) | ${( R , G , B , \sqrt{RG} , \sqrt{GB} , \sqrt{RB} , \sqrt[3]{{RG}^{2}} , \sqrt[3]{{RB}^{2}} , \sqrt[3]{{GB}^{2}} , \sqrt[3]{{GR}^{2}} , \sqrt[3]{{BG}^{2}} , \sqrt{{BR}^{2}} , \sqrt[3]{RGB} )}^{T}$ |
| 22 (RPK) | $\begin{matrix}( R , G , B , \sqrt{RG} , \sqrt{GB} , \sqrt{RB} , \sqrt[3]{{RG}^{2}} , \sqrt[3]{{RB}^{2}} , \sqrt[3]{{GB}^{2}} , \sqrt[3]{{GR}^{2}} , \sqrt[3]{{BG}^{2}} , \sqrt{{BR}^{2}} , \\ {\sqrt[3]{RGB} , \sqrt[4]{{R}^{3} G} , \sqrt[4]{{R}^{3} B} , \sqrt[4]{{G}^{3} R} , \sqrt[4]{{G}^{3} B} , \sqrt[4]{{B}^{3} R} , \sqrt[4]{{B}^{3} G} , \sqrt[4]{{R}^{2} GB} , \sqrt[4]{{G}^{2} RB} , \sqrt[4]{{B}^{2} RG} )}^{T}\end{matrix}$ |

In some cases, relying on kernel functions with higher degrees could hinder the generalization, often referred to as overfitting. In the present embodiments, the mapping Mᵢ is determined specifically for each pair of images. Hence, a kernel function with a higher degree may be preferable. In some cases, once the mappings Mᵢ are determined, the set of down-sampled output images, tᵢ may no longer be needed, and can thus be discarded. In this case, advantageously, only the mappings, having low resource requirements, are required to be retained. In general, nonlinear operations are applied during rendering. Because of these nonlinearities, lower kernel functions (having less polynomials) or linear 3×3 mapping operators may lead to underfitting; such that the mapping operator may not be the best fitting and capture the underlying trend of the source and target data. A higher degree for the kernel functions generally provide the ability to find the best fit to map the source image to the target image; however, they often require more computational time compared with kernel function with a lower degree. In the present inventors' example experiments, the kernel function 34 (PK) was determined to have the best performance characteristics in terms of computational time and fitting accuracy. In other cases, other suitable kernel functions and other suitable mappings Mᵢ based on Equation (1) can be used.

At block 214, the mapping module 156 can use the mappings Mᵢ to facilitate post-processing of the initial output image O to generate the modified output images O_{modified}. To determine each of the modified output images O_{modified}, the mapping module 156 can use

O_{modified}=MᵢΦ(O) (2)

where O_{modified} is the full-resolution modified output image as if it was “re-processed” with the i^{th} parameter kᵢ.

At block 216, the output module 158 stores or otherwise outputs one or more of the modified output images O_{modified}; for example, outputting to the output interface 136, or outputting for storage in the database 146, non-volatile storage 144, RAM 128, or a remote location. In some cases, the modified output images can be determined at a later time. In these cases, the output module 158 can output the initial output image O with the associated output down-sampled images {tᵢ}^{N}ᵢ₌₁ , or it can output the initial output image O with the associated mappings Mᵢ.

While the present embodiments describe generating output down-sampled images, it is understood that any representation can be used so long as the pixel values of the down-sampled images are retained; for example, histogram representations can be used.

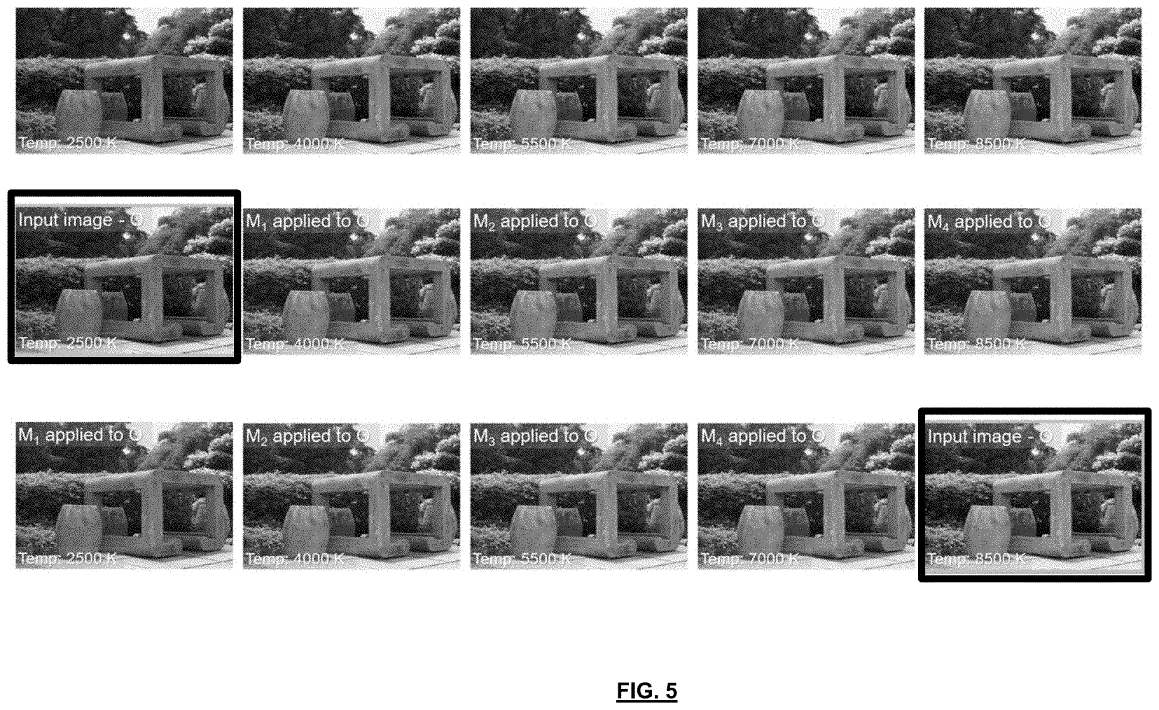

As an example experimental implementation of the present embodiments, FIG. 5 illustrates example outputs of the system 100. In FIG. 5, the top row illustrates the sensor image O processed with several different set of parameters j. In this case, the different parameters j are for different color temperatures of the white-balance. In FIG. 5, the middle and bottom rows illustrates the system 100 outputting modified output images O_{modified} by processing the initial output image O with different parameter sets kᵢ; in this case, each parameter set having different color temperatures for the white-balance. In the middle row, an initial output image O having a white-balance of 2850K is outlined while in the bottom row another initial output image O having a white-balance of 7500K is outlined. As illustrated, using the system 100, the initial output image O can be modified in post-processing, using the mapping operators Mᵢ, to make the output image O appear as if it was originally captured with the other white-balance settings. Notice the images in the middle row and bottom row are effectively visually indistinguishable from the top row, which is the actual output from the camera using different white-balance settings in the image processing pipeline.

Qualitative example evaluations conducted by the present inventors illustrate that the present embodiments can be used to apply post-processing modifications, for example, fix incorrectly white-balanced images or to produce visually pleasing variations of the image, with a reasonably small reconstruction error. For the example evaluations, for each image, the image processing pipeline down-sampled the demosaiced raw image into 150×150 pixels in order to generate five down-sampled images with the following color temperatures: 2500, 4000, 5500, 7000, and 8500. 34 (PK) was used as the kernel function. The mapping operators were represented as 34×3 matrices. As a result, the modified output images corrected white-balance in a way that was not reasonably distinguishable to the naked eye to white-balance corrected images that had been processed by the camera's image processing pipeline.

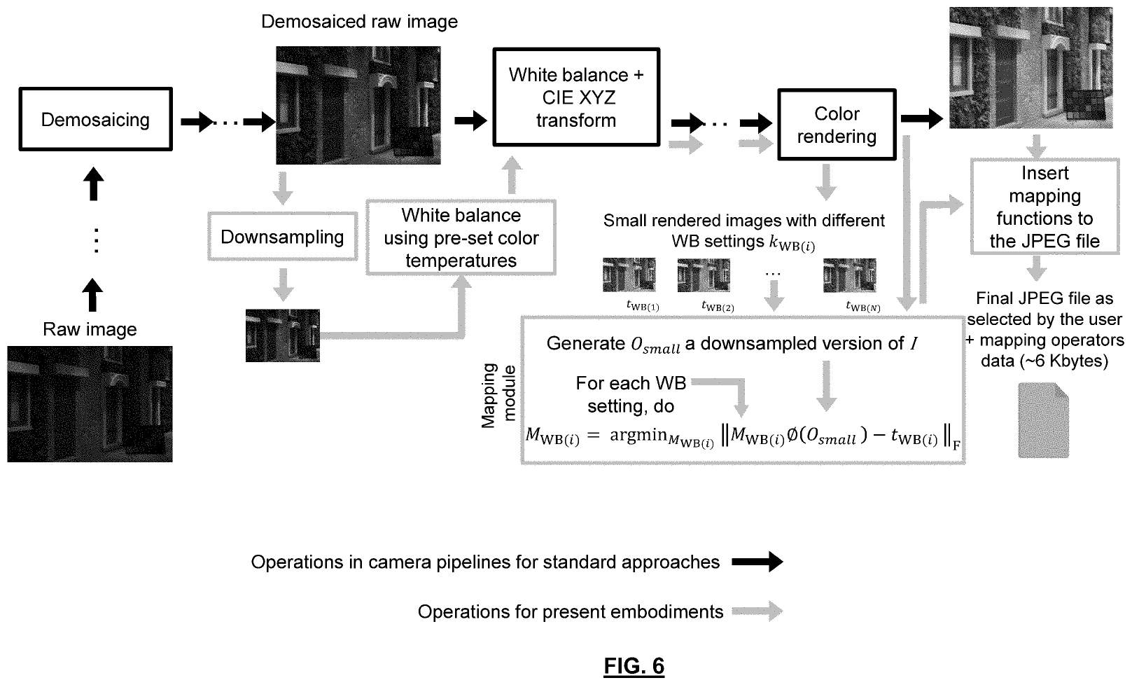

FIG. 6 illustrates an example flow diagram for generating an initial (referred to as original) output image with associated mappings for down-sampled modified images, according to the present embodiments. The down-sampled modified images, in this example, representing different white-balancing (WB) parameters. Also illustrated in the diagram of FIG. 6 is operations in a camera pipeline for other standard approaches, as described above.

Advantageously, the present embodiments provide the ability to use a down-sampled version of a captured raw image with different parameters to facilitate post-processing modification. The facilitation allows for an improvement in performance without requiring many modifications to the existing camera imaging pipelines. By using the down-sampled output images, the required computational time to compute the mapping function is very small and insignificant. Advantageously, the present embodiments can be incorporated into current camera imaging pipelines with relatively minimal modifications. Additionally, a stand-alone implementation can be used where RAW image capture is available.

Although the invention has been described with reference to certain specific embodiments, various modifications thereof will be apparent to those skilled in the art without departing from the spirit and scope of the invention as outlined in the claims appended hereto. The entire disclosures of all references recited above are incorporated herein by reference.

1. A method of processing of a captured image to facilitate post-processing modification, the method executed on one or more processors, the method comprising:
receiving the captured image;
down-sampling the captured image to generate a down-sampled captured image;
passing the captured image through an image processing pipeline to generate an initial output image, the image processing pipeline comprising performing one or more image processing operations on the passed image based on a set of parameters;
iteratively passing, in one or more iterations, the down-sampled captured image through the image processing pipeline to generate an output down-sampled image for each iteration, each iteration using at least one variation to the set of parameters used by the image processing pipeline; and
storing the initial output image and the one or more output down-sampled images.

2. The method of claim 1, further comprising: associating the one or more output down-sampled images with the initial output image; and outputting the initial output image with the associated one or more output down-sampled images.

3. The method of claim 2, wherein associating the one or more output down-sampled images with the initial output image comprises storing the one or more output down-sampled images as metadata to the initial output image.

4. The method of claim 1, wherein, in one iteration, the set of parameters disable the pipeline operations such that the down-sampled captured image is equivalent to the output down-sampled image, and storing the output down-sampled image as metadata to the initial output image.

5. The method of claim 4, wherein, in one iteration, the set of parameters disable the pipeline operations such that the down-sampled captured image is equivalent to the output down-sampled image, the method further comprising determining a mapping between the output down-sampled image and the captured image and storing the mapping as metadata to the initial output image.

6. The method of claim 1, wherein one of the image processing operations comprises performing white-balancing, and wherein the variation in the set of parameters comprises variations of color temperature for the white-balance.

7. The method of claim 1, further comprising:
down-sampling the initial output image to generate a down-sampled initial output image, the down-sampled initial output image comprising dimensions equivalent to the one or more output down-sampled images; and
for each of the output down-sampled images, determining a mapping between the down-sampled initial output image and the respective output down-sampled image.

8. The method of claim 7, wherein associating the one or more output down-sampled images with the initial output image comprises storing the mapping for each of the output down-sampled images as metadata to the initial output image.

9. The method of claim 7, wherein the mapping comprises a nonlinear mapping function that minimizes error between colors in the down-sampled initial output image and the respective output down-sampled image comprising the at least one variation to the set of parameters used by the image processing pipeline.

10. The method of claim 9, further comprising using a kernel function to transform red, green and blue (RGB) triplets of the down-sampled initial output image to a dimensional space that is greater than three dimensions, the minimization of error between the colors comprising minimizing a squared-distance between the down-sampled initial output image in the dimensional space and the respective output down-sampled image.

11. The method of claim 10, wherein the kernel function output comprising: (R, G, B, R², G², B², RG, RB, GB, R³, G³, B³, RG², RB², GB², GR², BG², BR², RGB, R⁴, G⁴, B⁴, R³G, R³B, G³R, G³B, B³R, B³G, R²G², G²B², R²B², R²GB, G²RB, B²RG)^{T}.

12. The method of claim 7, further comprising: associating the one or more mappings with the initial output image by storing the one or more output down-sampled images as metadata to the initial output image; and outputting the initial output image with the associated one or more mappings.

13. The method of claim 7, further comprising:
generating a modified output image by applying one of the one or more mappings to the initial output image; and
outputting the modified output image.

14. A method of generating one or more modified output images from a captured image, the method executed on one or more processors, the method comprising:
receiving an initial output image processed using an image processing pipeline from the captured image, the image processing pipeline comprising one or more image processing operations on the captured image based on a set of parameters;
receiving one or more mappings associated with the initial output image, each of the one or more mappings having been determined from a respective mapping between a down-sampled initial output image and one of one or more output down-sampled images, the one or more output down-sampled images having been determined by iteratively passing, in one or more iterations, a down-sampled image of the captured image through the image processing pipeline, each iteration using at least one variation to the set of parameters used by the image processing pipeline;
generating each of the one or more modified output images by applying one of the one or more mappings to the initial output image; and
outputting at least one of the modified output images.

15. A system of processing of a captured image to facilitate post-processing modification, the system comprising one or more processors and one or more non-transitory computer storage media, the one or more non-transitory computer storage media comprising instructions that cause the one or more processors to execute:
an input module to receive the captured image;
a down-sampling module to down-sample the captured image to generate a down-sampled captured image; and
an image processing module to pass the captured image through an image processing pipeline to generate an initial output image, the image processing pipeline comprising performing one or more image processing operations on the passed image based on a set of parameters, and to iteratively pass, in one or more iterations, the down-sampled captured image through the image processing pipeline to generate an output down-sampled image for each iteration, each iteration using at least one variation to the set of parameters used by the image processing pipeline.

16. The system of claim 15, the one or more processors further execute an output module to associate the one or more output down-sampled images with the initial output image, and to output the initial output image with the associated one or more output down-sampled images as metadata to the initial output image.

17. The system of claim 15, wherein the down-sampling module further down-samples the initial output image to generate a down-sampled initial output image, the down-sampled initial output image comprising dimensions equivalent to the one or more output down-sampled images, and the one or more processors further execute a mapping module to, for each of the output down-sampled images, determine a mapping between the down-sampled initial output image and the respective output down-sampled image.

18. The system of claim 17, wherein the mapping comprises a nonlinear mapping function that minimizes error between colors in the down-sampled initial output image and the respective output down-sampled image comprising the at least one variation to the set of parameters used by the image processing pipeline.

19. The system of claim 18, wherein the mapping module further uses a kernel function to transform red, green and blue (RGB) triplets of the down-sampled initial output image to a dimensional space that is greater than three dimensions, the minimization of error between the colors comprising minimizing a squared-distance between the down-sampled initial output image in the dimensional space and the respective output down-sampled image.

20. The system of claim 18, wherein the one or more processors further execute an output module to associate the one or more mappings with the initial output image by storing the one or more output down-sampled images or the mappings as metadata to the initial output image, and to output the initial output image with the associated one or more mappings.
